(19) United States
(12) Patent Application Publication
(10) Pub. No.: US 2006/0278501 A1
(43) Pub. Date: Dec. 14, 2006

(54) Conveyor/sorter apparatus and method

(76) Inventor: Eric W. Sweazy, Danville, KY (US)

Correspondence Address: DINSMORE & SHOHL, LLP, 1900 CHEMED CENTER, 255 EAST FIFTH STREET, CINCINNATI, OH, 45202, US

(21) Appl. No.: 11/219,174

(22) Filed: Sep. 2, 2005

Related U.S. Application Data
(60) Provisional application No. 60/606,815, filed on Sep. 2, 2004.

(51) Int. Cl. B65G 47/10

(52) U.S. Cl. 198/890

(57) ABSTRACT

A conveyor system for conveying and/or sorting articles includes an endless track assembly having a conveying path and a plurality of cartridges for receiving articles and discharging the articles. The cartridges are supported from the track assembly and moveable along the conveying path. The cartridges are configured to move transverse to the conveying path between at least two discharge positions. A method for conveying and/or sorting articles is also provided.

### RELATED APPLICATION

The present application claims priority of U.S. Provisional Application Serial No. 60\606,815 filed Sep. 2, 2004 and hereby incorporates the same Provisional Application by reference.

### FIELD OF THE INVENTION

The present invention relates to conveyor systems for conveying and/or sorting articles such as merchandise, packages, postal articles, CD's, etc. The present invention also relates to methods for conveying and/or sorting articles such as merchandise, packages, postal articles, CDs, etc. In particular, the invention relates to a conveyor which allows a high degree of adaptability to requirements or constraints with respect to the space it can occupy and the path along which the conveyor units can travel.

### BACKGROUND OF THE INVENTION

Conveyors for merchandise, postal articles (e.g., letters, flats, etc.), mail parcels, CDs, videotapes, books and other articles should be designed so that they can be installed relatively easily and operated under widely varying space conditions, both with regard to the amount of space the conveyors can occupy and with respect to the three-dimensional configuration of the space available.

### BRIEF DESCRIPTION OF THE DRAWINGS

The following detailed description will be more fully understood in view of the drawing in which:

FIG. 1 is a perspective view of a conveyor system according to one embodiment of the present invention;

FIG. 2 is a perspective view of a portion of a conveyor system according to one embodiment of the present invention;

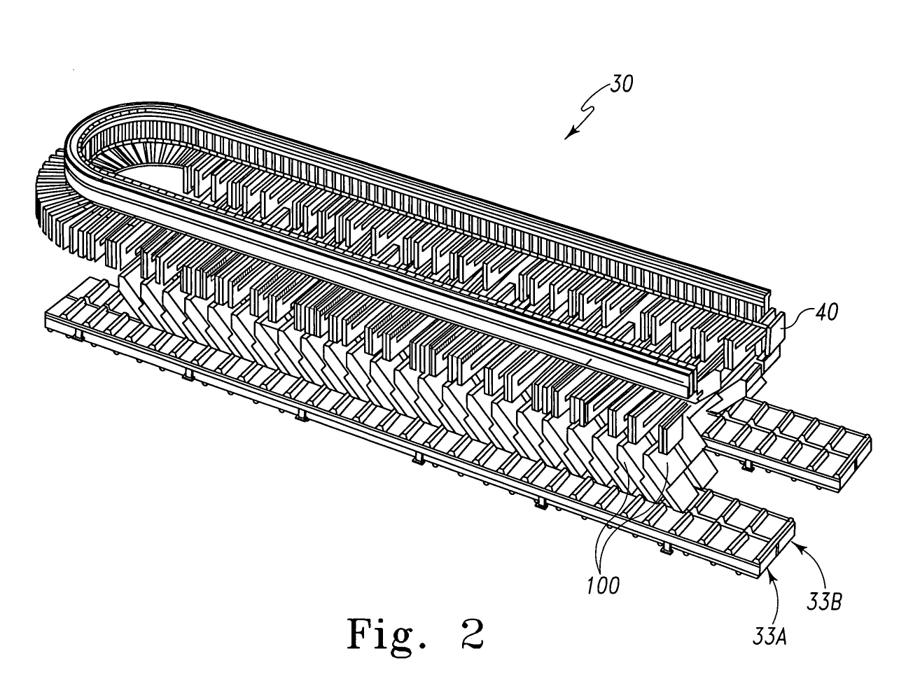

FIG. 3 is a perspective view of a portion of a conveyor system according to one embodiment of the present invention;

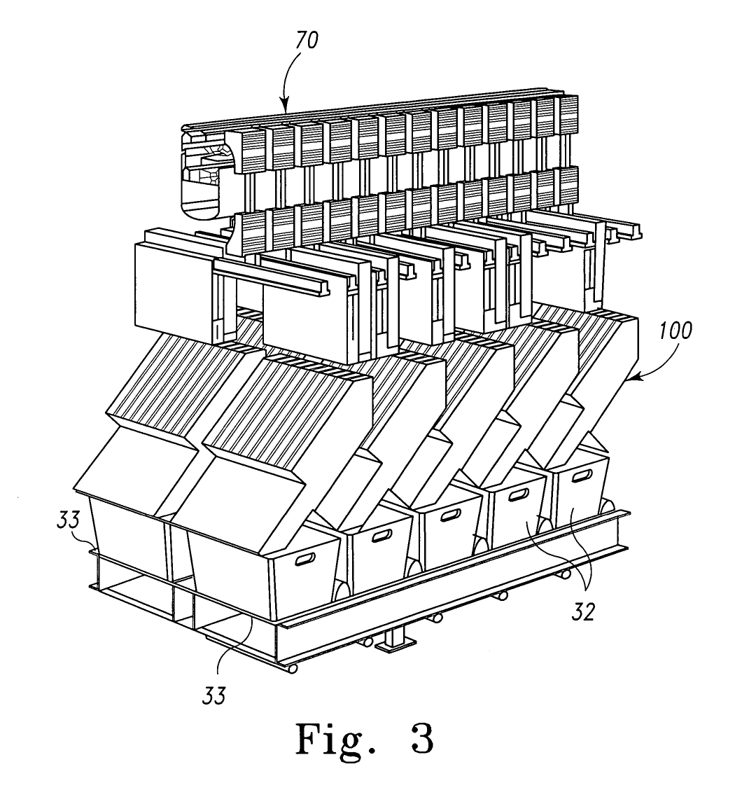

FIG. 4 is a perspective view of a portion of a conveyor system according to one embodiment of the present invention, depicting the cartridges being transversely moved to the outside portion of a curved section of the conveying path;

FIG. 5 is a perspective view of a carriage assembly, cartridge and support rail according to one embodiment of the present invention;

FIG. 6 is a perspective view of a portion of a conveyor system according to one embodiment of the present invention;

FIG. 7 is a side view of a cartridge according to one embodiment of the present invention;

FIG. 8 is a schematic view of a letter feeder in conjunction with a portion of a conveyor system according to one embodiment of the present invention;

FIGS. 9 and 10 are top and side schematic views, respectively, of a flats feeder in conjunction with a portion of a conveyor system according to one embodiment of the present invention;

FIG. 11 is a side view of a portion of a conveyor system according to one embodiment of the present invention;

FIG. 12 is a cross-sectional view of a monorail assembly, carriage assembly, cartridge and support rail according to one embodiment of the present invention;

FIG. 13 is a perspective view of a conveyor system according to one embodiment of the present invention; and

FIG. 14 is a top schematic view of a conveyor system according to one embodiment of the present invention.

The embodiments set forth in the drawing are illustrative in nature and are not intended to be limiting of the invention defined by the claims. Moreover, individual features of the drawing and the invention will be more fully apparent and understood in view of the detailed description.

### DETAILED DESCRIPTION

The present invention is directed to conveyor systems for conveying and/or sorting articles, as well as methods for conveying and/or sorting articles. While the present invention is not so limited, the conveyor systems disclosed herein are particularly suitable for use in conveying and sorting postal articles such as letters, flats, and similarly-sized postal articles. (“Flats” are larger, flat mail pieces such as large envelopes, magazines, catalogs, etc.) For example, the conveyor systems of the present invention may be used to sort postal articles into a single bundle of articles for each delivery point (e.g., a bundle of letters and flats for each mailing address). This bundle may include both letters and flats, as the conveyor systems of the present invention may be configured to merge all of these items into a single bundle (e.g., utilizing cartridges which accommodate two or more distinct sizes of articles such as letters and flats). The result is that the carrier is provided with a single bundle of “mixed” mail for each delivery point.

The conveyor systems of the present invention are also modular in nature, particularly the main track assembly (e.g., a monorail assembly) which may be assembled in any of a variety of configurations. Also, the conveyor systems of the present invention maximize the use of space, in that the transport path may include small radius curves, multiple levels, and even changes in elevation. As further discussed herein, the main track assembly (e.g., a monorail) may be similar or identical in construction to the various embodiments described in U.S. Pat. No. 6,533,106 (“the '106 patent,” which is incorporated herein by way of reference). One of the principal distinctions between the systems of the present invention and those described in the '106 patent is that, in the '106 patent, conveyor units (identified by reference numeral 1 therein) employ a “cross-belt” design for discharging articles to either side of the conveying unit. In the present invention, on the other hand, cartridges for receiving and discharging the sorted articles are transversely movable with respect to the main track assembly.

In particular, the present invention provides conveyor systems for conveying and/or sorting articles wherein the articles are inserted into a plurality of cartridges movingly supported by a main track assembly. The cartridges are supported by the track assembly such that the cartridges will travel along a transport (or conveying) path defined by the course of the track assembly. In addition, the cartridges are supported by the track assembly such that the cartridges may also move in a direction transverse or perpendicular to the transport path defined by the track assembly. In this manner, the cartridges are configured such that as they proceed along the path defined by the main track, the individual cartridges may be moved transverse to the conveying path to a plurality of discharge positions. Once at a discharge position, the article(s) within the cartridge may be discharged from the cartridge at a predetermined location. By way of example, a series of compartments (such as bins) may be positioned beneath the cartridges at predetermined locations such that article(s) discharged from a cartridge at a selected one of the plurality of discharge positions will be deposited into the compartment located beneath that cartridge.

In one exemplary embodiment depicted and described further herein, each cartridge is configured such that the article(s) (e.g., letters and flats) inserted therein and later discharged therefrom are positioned vertically (i.e., upright) within the cartridge. The cartridges are transversely moveable with respect to the conveyor path such that the article(s) contained within the cartridges are maintained in their vertical orientation during the transverse cartridge movement. In a particular embodiment, each cartridge is supported by a support rail (or guide bar) such that the cartridge may slide along the support rail to effect the transverse cartridge movement. Furthermore, the support rail may be suspended from the main track assembly such that the cartridge will travel along the conveyor path defined by the main track assembly via the support rail.

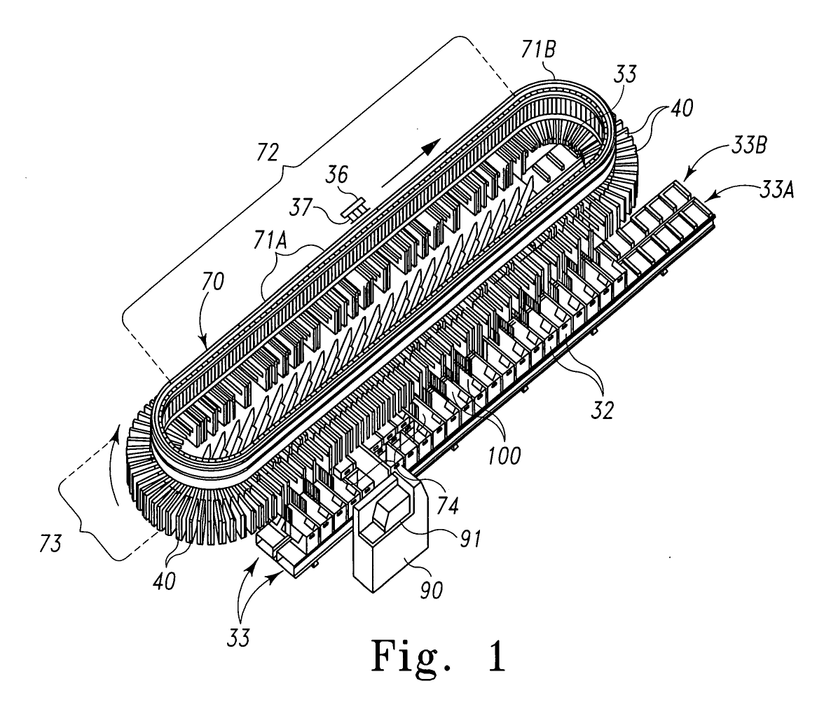

FIG. 1 is a perspective view of an exemplary conveyor/sorting system 30 according to one embodiment of the present invention. It should be pointed out that the system depicted in FIG. 1 is a simplified version, as a typical installation may often employ a considerably longer main track assembly 70 having multiple sort legs, one or more separate induction legs and even multiple levels (as further described herein). The exemplary system depicted in FIG. 1 includes main track assembly 70 in the form of an endless loop. Main track assembly 70 may be assembled 70, for example, from straight sections 71a and curved section 71b assembled in an end-two-end fashion in order to provide the endless loop (as further detailed in the '106 patent). A plurality of cartridges 40 are movingly supported by track assembly 70 such that cartridges 40 may travel in serial fashion along the path defined by the course of track assembly 70 (in a clockwise manner in the exemplary embodiment shown in FIG. 1).

In FIG. 1, main track assembly 70 includes a pair of parallel, spaced-apart straight legs (or sorter legs) 72, and a pair of curved legs 73 connecting adjacent ends of the two straight legs 72. One of the straight legs 72 of main track assembly 70 in FIG. 1 also includes an induction section 74, as shown. As further described herein, a separate induction leg may be used in embodiments of the present invention instead of an induction section comprising a portion of a sorter leg of the main track assembly.

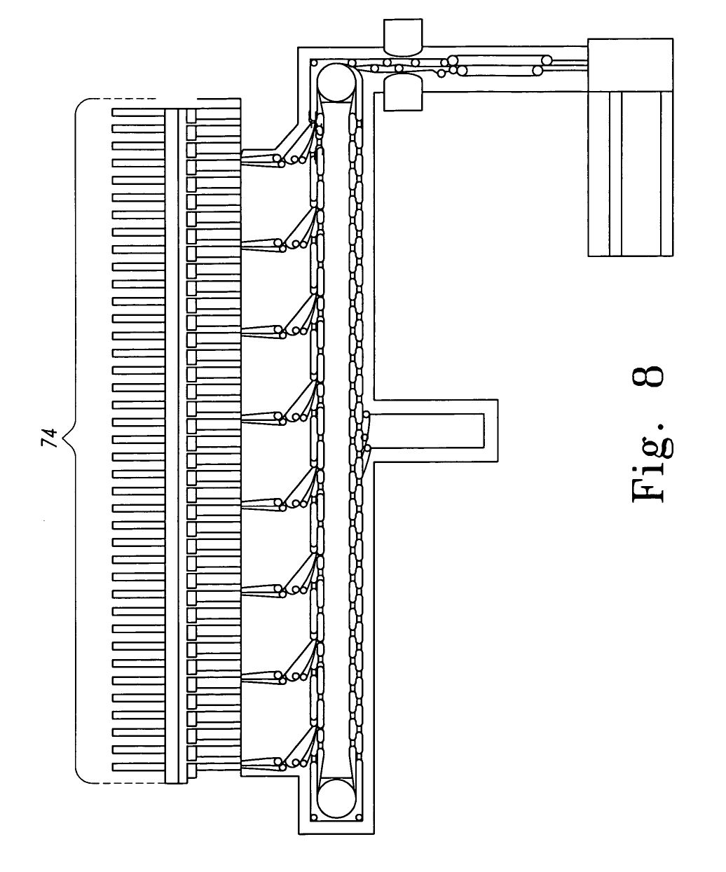

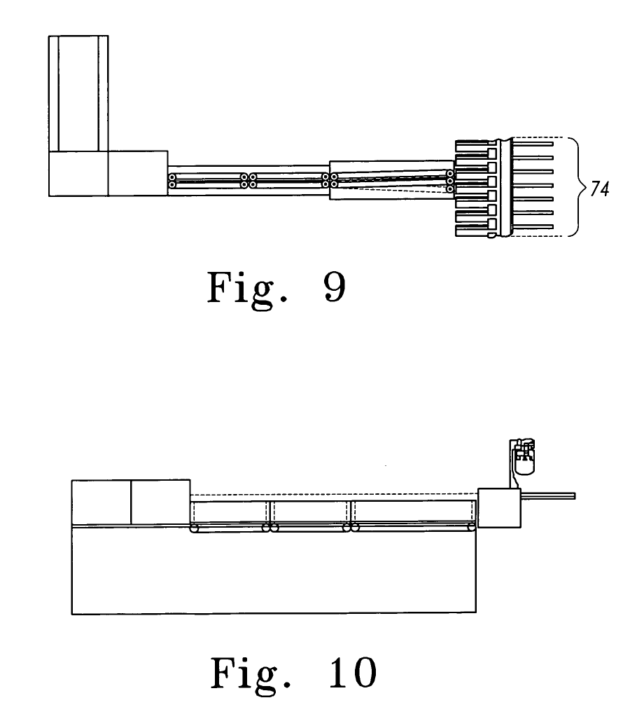

In the embodiment of FIG. 1, articles to be conveyed and/or sorted are inserted into cartridges 40 at induction section 74. Articles may be inserted into cartridges 40 by hand, or by means of a suitable feed/insertion device. The system of FIG. 1 is particularly suited for the conveying and sorting of mail, such as letters and flats. Thus, the exemplary embodiment of FIG. 1 includes a feeder 90 which is adapted to individually insert letters from a stack 91 into the cartridges 40 at induction section 74. Feeders known to those skilled in the art may be used for this purpose. Other exemplary feed/insertion devices which may be used with the systems of the present invention are shown in FIGS. 8-10 (wherein FIGS. 9 and 10 are different views of a device for feeding/inserting flats into cartridges 40).

As mentioned previously, cartridges 40 not only travel along the conveying path defined by main track assembly 70, each individual cartridge 40 may be moved transversely with respect to the conveying path (i.e., the transport path defined by the track assembly 70). In the embodiment of FIG. 1, each cartridge 40 is independently moveable in a transverse direction between a pair of discharge positions. In particular, cartridges 40 are moveable between an outer discharge position wherein the cartridge extends outwardly away from the closed loop defined by main track assembly 70, and a second, inner discharge position in which the cartridge extends inwardly (when viewed from above) with respect to the closed loop defined by main track assembly 70.

As also seen in FIG. 1, a pair of conveyors 33 (e.g., flighted conveyors) are located beneath each straight (or sorter) leg 72 of main track assembly 70. In general, each pair of conveyors 33 is aligned with main track assembly 70 such that the adjacent longitudinal edges of adjacent conveyors are directly beneath and aligned with the centerline of main track assembly 70. Furthermore, when a cartridge 40 is located at a discharge position, the cartridge 40 will be located directly above (aligned with) one of the conveyors 33. Thus, for example, when a cartridge 40 is located at its outer discharge position (extending outwardly away from the loop defined by main track assembly 70), the cartridge will be located directly above conveyor 33A. When a cartridge 40 is located at its inner discharge position, it will be positioned directly above conveyor 33B. As further described herein, each cartridge 40 includes one or more “bomb bay” style doors through which articles may be discharged directly beneath the cartridge. Therefore, by aligning a conveyor and/or other suitable receptacle beneath the first and second discharge positions for the cartridges along a sorter leg, articles within the cartridges may be selectively discharged into (or onto) the conveyor and/or receptacle.

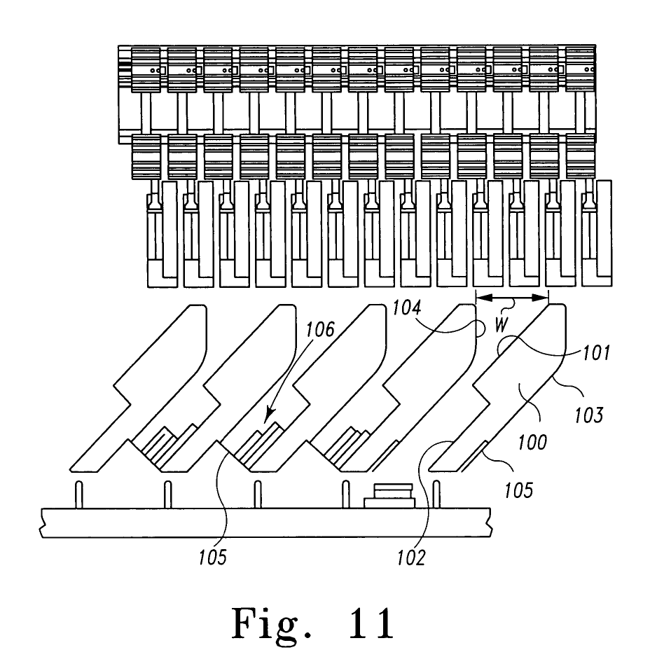

In the embodiment shown in FIG. 1, a series of bins 32 are located on conveyors 33 for receiving articles discharged from the cartridges 40. Conveyors 33 may also be configured to ensure that the bins are aligned on the conveyor in a predetermined fashion in order to ensure that the articles are deposited into the appropriate bin. Alternatively, articles may be deposited directly onto the upper surface of the conveyors, and therefore the conveyors may include discrete zones (see FIG. 11) for receiving articles discharged from the cartridges.

As further described herein, a series of chute/buffer modules 100 may be provided between cartridges 40 and conveyors 33 in order to guide discharged articles onto the conveyor or into a receptacle (e.g., a bin) positioned on the conveyor. Chute/buffer modules 100 may also act as a destination buffer for accumulating articles discharged from the cartridges, and later depositing accumulated articles into a receptacle on the conveyor therebeneath or onto the conveyor itself.

By way of example, and with reference to FIG. 1, postal articles for a single postal carrier may be inserted into cartridges 40 traveling along the conveyor path (e.g., using one or more feed devices 90 or similar apparatus). The control system will designate a receptacle (e.g., a bin 32) on one of the conveyors 33 for receiving all of the postal articles for a particular delivery destination (e.g., a single mailing address such as the street address for a house). After the induction section or leg, as the cartridges continue to proceed about the conveying path to sorter leg, individual cartridges will be moved transversely to the conveying path, as necessary, in order to align the cartridge directly above the conveyor on which the bin 32 designated for the postal article within the cartridge is positioned. In the exemplary embodiment of FIG. 1, since there are only two discharge positions for each cartridge (i.e., outside of conveyor path loop and inside of conveyor path loop), some of the cartridges will not need to be transversely moved in order to align the cartridge over the appropriate conveyor.

Cartridges will be transversely moved prior to reaching the designated bin 32. Thereafter, when the cartridge is above the designated bin, the postal article will be discharged into that bin or into the destination buffer located above the bin. In either case, cartridges will continue to travel around the conveyor path, and will be transversely moved as needed in order to discharge postal articles into the appropriate bins (or destination buffers). Since each cartridge may have multiple article compartments (as further described herein), each cartridge may be transversely moved multiple times as the cartridge proceeds along the conveying path. In addition, depending on the quantity of articles being sorted, the cartridges may make multiple passes around the conveying path loop until the entire set of postal articles have been sorted. If the destination bins are being employed, once all of the postal articles for a designated bin have been deposited into the destination buffer, the buffer will discharge the sorted articles into the designated bin therebeneath. Thereafter, the bins may be removed, such as by advancing the bins along conveyors 33 to further processing and/or to the postal carrier for delivery.

As best seen in FIG. 11, since the present invention allows cartridges 40 to be positioned much closer to one another than, for example, the width of standard mail bins used by postal carriers, the centerline distance between adjacent chute/buffer modules 100 may be greater than the centerline distance between adjacent cartridges. In the embodiment shown, the centerline distance between adjacent chute/buffer modules 100 is at least twice the centerline distance between adjacent cartridges 40.

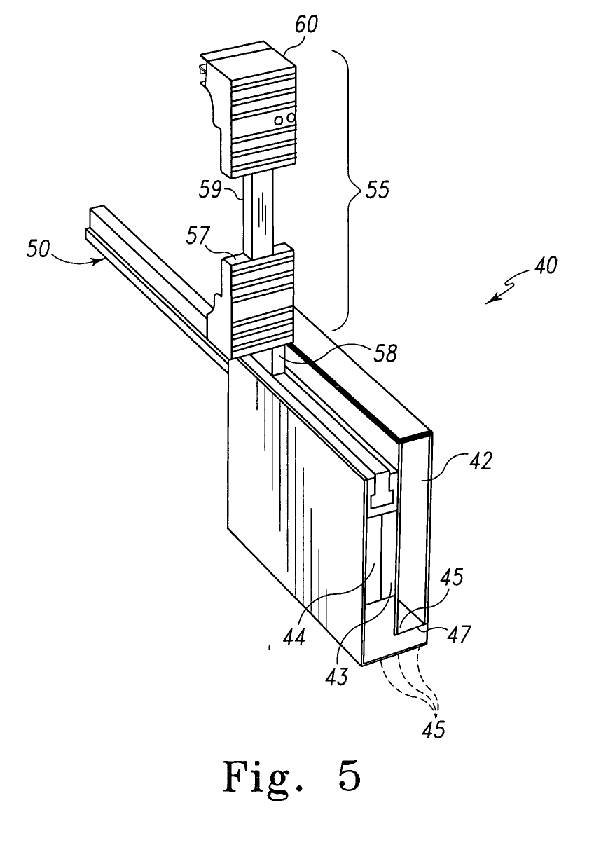

FIGS. 5-7 depict an exemplary embodiment of a cartridge 40 according to aspects of the present invention. Rectangular cartridge 40 is particularly suited for receiving and discharging postal items (including both letters and flats) and articles of similar size and shape. However, the present invention is not limited to systems for conveying and/or sorting postal items, as it may be used for a variety of other particles.

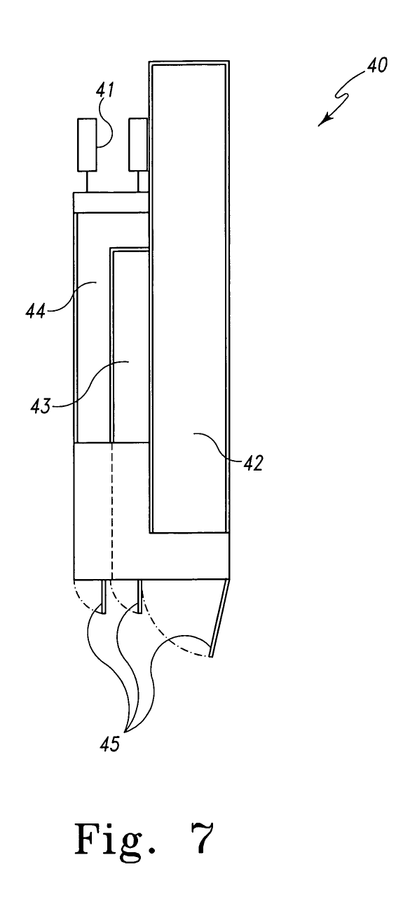

In the embodiment shown in FIGS. 5-7, cartridge 40 includes three compartments (or pockets) configured for receiving postal items. Of course this is merely exemplary, as the cartridge may include a single compartment, or any number of compartments, as desired. As best seen in FIG. 7, cartridge 40 includes a first compartment 42, a second compartment 43, and a third compartment 44. In the embodiment shown, first compartment 42 has a greater height and thickness as compared to compartments 43 and 44. The width of all three compartments may be identical, extending across the entire width of cartridge 40. In a particular embodiment, first compartment 42 is sized and configured to receive postal flats (e.g., large envelopes, magazines, etc.), and second and third compartments 43 and 44 are sized and configured to receive postal envelopes of standard size.

As also seen in FIG. 5, compartments 42-44 are open along either side such that postal items may be inserted into the compartments through either open side. However, in order to help ensure that each postal item remains in its respective compartment until being discharged therefrom, the side openings for each compartment may not extend the entire height of the compartment. Thus, the interior base or floor 45 of first compartment 42 is lower than the lowermost edge 47 of the side opening for first compartment 42. In this manner, when a postal item is inserted into first compartment 42 through the side opening, the postal item will fall downwardly until it reaches base 45 of first compartment 42.

In the exemplary embodiment shown, the base or floor of each compartment 42-44 of cartridge 40 may comprise a hinged door (or discharge gate) 45, as best seen in FIG. 7. Once an article has been inserted into one of the compartments on cartridge 40, and the cartridge is at the appropriate discharge position and at the desired location along the transport path, the discharge gate 45 may open (as seen in FIG. 7) such that the article will fall downwardly from the compartment (and thus discharged from cartridge 40). The opening of discharge gates 45 may occur under the direction of a control system for conveyor/sorting system 30 in order to ensure that the article is discharged at the appropriate location. The control system may communicate with each cartridge 40 through, for example, one or more wires extending from cartridge 40 through support rail 50 and carriage 55. Alternatively, cartridge 40 may receive wireless signals from the control system via a wireless transmitter(s) provided along track assembly 70 (e.g., infrared or RF transmitters positioned along the length of track assembly 70).

As seen in FIG. 7, discharge gates 45 are hingedly attached to the base of cartridge 40. The gates may be attached by means of, for example, a torsion spring hinge. The gates on a single cartridge may be configured to open simultaneously and/or individually. Although the control system may send a signal to the cartridge 40 to direct one or more of the gates 45 to open, it is also contemplated that a release mechanism may be provided at each discharge point along the conveying path. Although a mechanism for closing the gates after article discharge may be provided on each cartridge, it is also contemplated that an armature(s) or other fixed member may be positioned just prior to the induction station or leg for closure of the gates. For example, armatures located directly beneath the traveling cartridges may be positioned and configured such that as a cartridge passes over the armatures, any open discharge gates will be urged to a closed position by the armatures (and a latching mechanism will ensure that the gates remain closed until proper article discharge).

As mentioned previously, each cartridge 40 may be individually and selectively moved in a direction which is transverse with respect to the conveyor path (i.e., the transport path defined by track assembly 70). In the exemplary embodiment shown, such transverse movement may be provided by means of a support rail (or T-bar) 50 upon which cartridge 40 is slidingly moveable. Support rail 50 may comprise an elongate beam having a key-shaped cross-section. However, it will be appreciated that support rail 50 may have any of a variety of cross-sectional shapes, provided that cartridge 40 includes a correspondingly-shaped slot for receiving support rail 50.

In the embodiment shown, each cartridge 40 includes a slot 41 extending along an upper surface of cartridge 40 and having a T-shaped cross-section which is sized and configured to receive support rail 50 (see FIG. 7). In the embodiment shown, the upper surface of cartridge 40 has a stepped configuration since first compartment 42 has a greater height than second and third compartments 43 and 44. Slot 41 is located above second and third compartments 43 and 44, as shown.

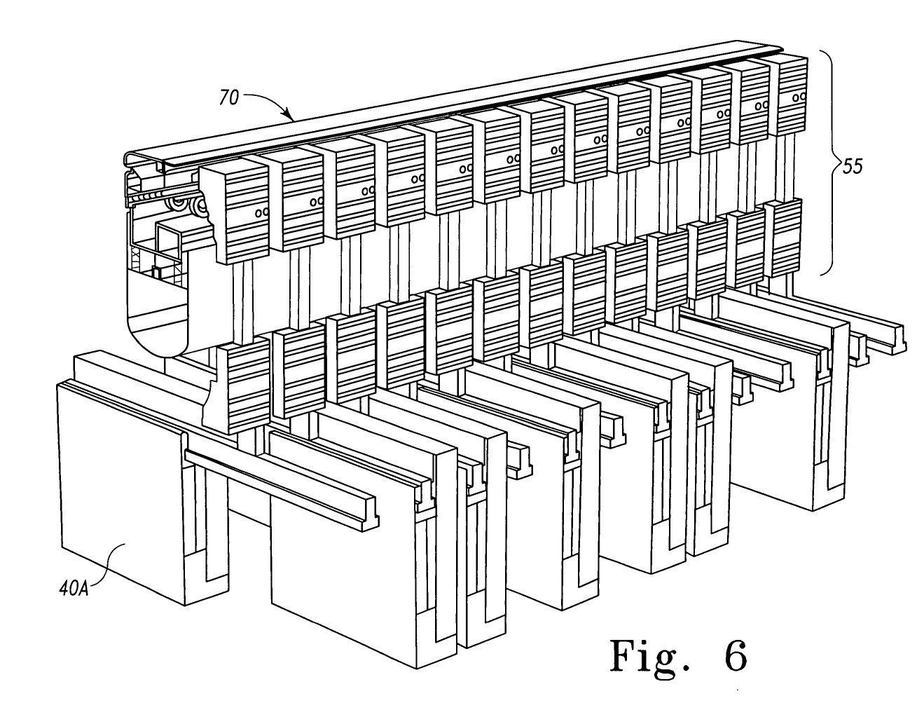

As also mentioned previously, each cartridge 40 in the exemplary embodiment depicted is transversely moveable between a pair of discharge positions. In this embodiment depicted in the drawings, each cartridge 40 is moveable between opposite ends of support rail 50. For example, in FIG. 6, cartridge 40A is at its first discharge position and cartridge 40B is located at its second discharge position (i.e., at the opposite end of its support rail 50 as compared to cartridge 40A). Of course any number of discharge positions may be provided, particularly if support rail 50 is lengthened. A home position for each cartridge 40 may also be provided whereat the cartridge is located at the center of support rail 50. For example, cartridges 40 may be moved to their home position for the insertion of articles into the compartment(s) of the cartridge.

Each cartridge 40 may be moved along its support rail 50 in a variety of manners. For example, a mechanical pusher located adjacent main track assembly 70 may be used to selectively push individual cartridges from one discharge position to another. In the exemplary embodiment shown in FIG. 1, a mechanical pushing device 36 having one or more pusher arms 37 is shown. Device 36 is located outside of the loop of main track assembly 70. A similar device 36 would generally also be positioned within the interior of the loop provided by main track assembly 70 (however it is not shown in FIG. 1). Under the direction of a control system for conveyor/sorting system 30 in FIG. 1, pusher arms 37 may be actuated such that arms 37 will selectively move cartridges along their respective support rails 50 in a direction transverse to the conveying path defined by track assembly 70. Any number of pushing devices 36 having any number of pushing arms 37 may be provided, and they may be located at a variety of positions along main track assembly 70. Pushing devices 36 may, for example, be located immediately following a curved section of main track assembly 70, with pushing devices located adjacent opposite sides of track assembly 70.

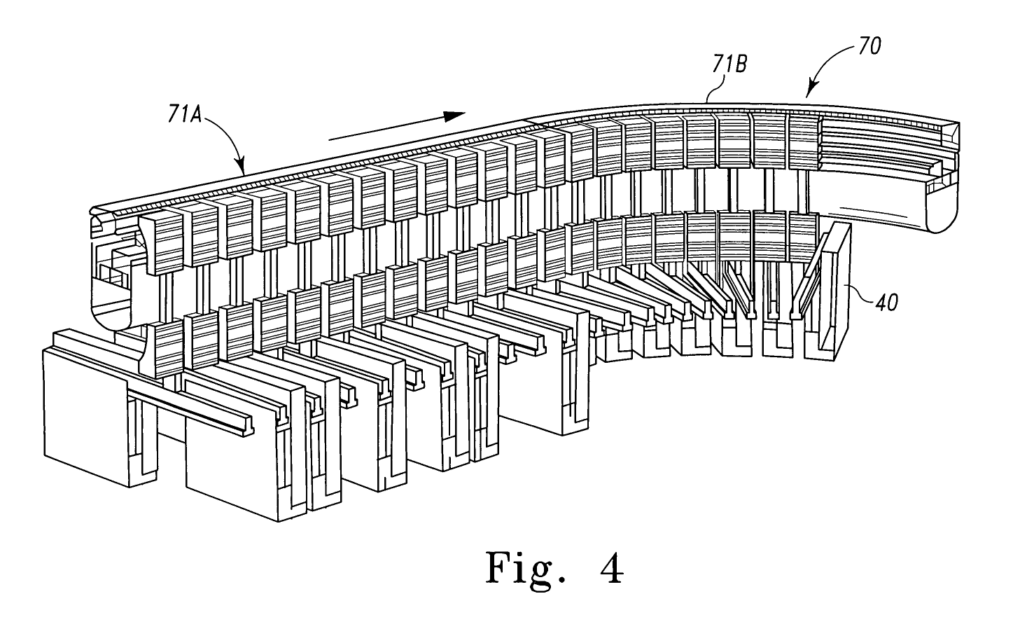

As further described herein, one advantage provided by the present invention is that as the cartridges 40 travel along the conveying path defined by main track assembly 70 towards a curved section of track assembly 70, each cartridge 40 may be transversely moved in a direction opposite to the upcoming curve. This is best seen in FIG. 4, for example, wherein, when viewed from above, cartridges 40 are traveling along the conveying path defined by main track assembly 70. As cartridges 40 approach a right-hand curved section 71B, the cartridges are moved transversely with respect to the conveying path such that the cartridges will travel around the curve in an outside position with respect to the curved section 71B. In this manner, the maximum possible clearance is provided between cartridges 40 during turns, thus allowing the cartridges to be positioned closer to one another while still allowing the cartridges to travel around smaller radius curves. This feature will maximize space usage since not only can the cartridges be positioned closer to one another, the radius of curves provided along the conveying path may be minimized. Thus, when mechanical pushing devices are employed, they may be located immediately before and immediately after curved portions of the conveying path.

As an alternate to the pushing devices described above for transverse movement of cartridges 40, the system of the present invention may alternatively employ a sliding shoe sorter device well-known to those skilled in the art.

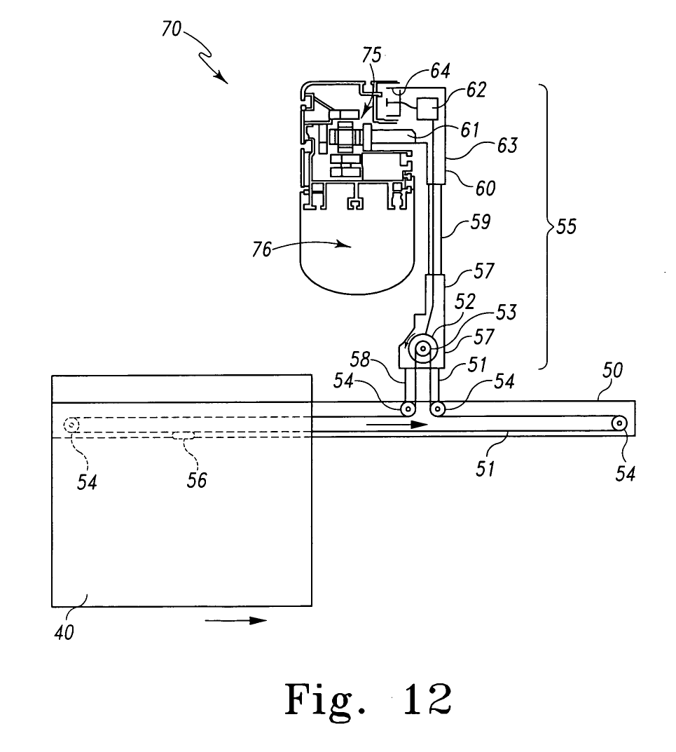

As yet another alternative, and as shown in FIG. 12, a transverse drive mechanism may be provided within support rail 50. In the particular embodiment shown, a cartridge drive belt 51 located within support rail 50 and attached to cartridge 40 may be used to transversely move cartridge 40 back and forth along support rail 50 between discharge positions.

As shown in FIGS. 5, 6, and 12, support rail 50, and hence cartridge 40, is supported from main track assembly 70 by means of a carriage assembly 55. Carriage assembly 55 is slideably supported on main track assembly 70 (as further described herein), and includes a mounting pin 61 secured to control box assembly 60. As further described herein, mounting pin 61 is used to attach carriage assembly 55 to a moving chain within main track assembly 70. Carriage assembly 55 further includes a first suspension arm 59, a motor box assembly 57 and a second suspension arm 58. Motor box assembly 57 is rigidly suspended from control box assembly 60 via first suspension arm 59. Similarly, support rail 50 is rigidly suspended from motor box assembly 57 by means of second suspension arm 58, such that second suspension arm 58 will not interfere with the transverse movement of cartridge 40 along suspension arm 50.

Belt 51 may be positioned within the interior of support rail 50, as shown in the cross-sectional view of FIG. 12. Belt 51 may also extend through the interior of section suspension arm 58 into the interior of motor box assembly 57, as also shown in FIG. 12. A series of pulley wheels 53 and 54 may be located within support rail 50 and motor box assembly 57 such that belt 51 extends around the pulley wheels, as shown. In order to drive belt 51, pulley wheel 53 in motor box assembly 57 may be controllably driven by a motor 52 attached to pulley wheel 53. Motor 52 is bi-directional in that it may be selectively driven clockwise or counterclockwise such that belt 51 is selectively moveable in either direction.

Belt 51 may be attached to cartridge 40 by means of a connector 56 which extends through the bottom wall of support rail 50. Thus, the bottom surface of support rail 50 includes a slot extending along at least a portion of the length of support rail 50, such that connector 56 may extend through this slot for attachment to cartridge 40 at a point adjacent the interior of slot 41 in the upper surface of cartridge 40. In this manner, as belt 51 is driven around pulley wheels 53 and 54 within support rail 50, cartridge 40 will be advanced along support rail 50 between its first and second discharge positions (i.e., from one end of support rail 50 to the other).

For example, if pulley wheel 53 is rotated counterclockwise by motor 52 as shown in FIG. 12, belt 51 will traverse pulley wheels 53 and 54 in a counterclockwise direction, thereby causing cartridge 40 to slide along support rail 50 in the direction shown.

In order to provide power to motor 52, as well as control the actuation of motor 52, one or more wires 63 may provide electrical power and/or control signals to motor 52. These wires may extend through the interior of control blocks assembly 60, first suspension arm 59 and motor box assembly 57, as shown. Wires 63 may be in electrical communication with a card controller board 62 which controls the transverse movement of cartridge 40 (e.g., in response to signals received from a control system via track assembly 70). Similarly, one or more control wires may also extend through carriage assembly 55 to cartridge 40 in order to provide actuation signals for the controlled opening of the discharge gates provided on the bottom of cartridge 40. By way of example, one or more wires may be embedded into belt 51 and connect to cartridge 40 via connector 56 in order to provide electrical communication between cartridge 40 and, for example, card controller board 62.

In order to provide power to carriage assembly 55, an inductive power transfer system may be employed, as described in detail in U.S. Pat. No. 6,571,933 (“the '933 patent,” which is incorporated herein by way of reference). While the '933 patent provides a detailed description of a suitable inductive power transfer system which may be used in the present invention, it should be pointed out that in FIG. 12 herein secondary rails 64 comprising two U-shaped rails extend away from control box assembly 60 as shown. These secondary rails 64 correspond to the secondary rails identified by reference numeral 3 in the drawings and description contained in the '933 patent. Of course a variety of other means may be employed for providing power to carriage assembly 55, as needed.

Main track assembly 70 may be configured in the manner described in detail in the '106 patent. In particular, main track assembly 70 may comprise a monorail assembly, and each carriage assembly 55 is mounted to a drive chain assembly 75. In this manner, mounting pin 61 in FIG. 12 herein is equivalent to pivot pin 35 described and shown in the '106 patent. As further described in the '106 patent, a plurality of support and guide wheels may be employed to facilitate movement of carriage assembly 55 along main track assembly 70. Any of the various drive means described in the '106 patent may be employed for the controlled movement of carriage assembly 55 along track assembly 70. Alternatively, a screw drive assembly may be provided in the lower compartment 76 of main track assembly 70 and connected to chain assembly 75 for purposes of driving the carriage assemblies 55 along track assembly 70.

The configuration and operation of discharge chute/buffer modules 100 is best seen in FIG. 11. Each module 100 includes an upper front wall 101, a lower front wall 102, a bottom wall 103, and an upper side wall 104. Modules 100 are positioned such that front walls 101 and 102 are angled rearwardly with respect to the direction of conveyor travel. The front wall of each module 100 is also stepped such that a buffer compartment 106 may be provided between lower front wall 102 and the bottom wall 103 of an adjacent module. A gate 105 may be hingedly attached to the bottom wall 103 of each module at a lower portion thereof. Gate 105 may be selectively moved between closed and open positions. When in its closed position, gate 105 extends from bottom wall 103 to lower front wall 102 of an adjacent module. In this manner, gate 105 acts as a discharge door for buffer compartment 106. In its open position, gate 105 may lie against bottom wall 103, as shown. Gate 105 may be selectively opened to release articles accumulated within the corresponding buffer compartment 106 (e.g., onto zoned conveyor or into a receptacle positioned on a conveyor positioned directly beneath the buffer compartment).

In the embodiment shown, bottom wall 103 may be generally parallel to front walls 101 and 102. However, bottom wall 103 may be shorter than the combined length of front walls 102 and 103 such that an upper side wall 104 extends upwardly away from bottom wall 103, as shown. In this manner, the width W of the chute throat opening provided between the upper end of upper side wall 104 and the upper end of the upper front wall 101 of the adjacent module will be increased. Articles discharged from a cartridge will fall downwardly into the chute throat opening and will be directed by the front walls 101 and 102 into the appropriate region of the zoned conveyor shown in FIG. 11 or into the appropriate receptacle positioned on a conveyor.

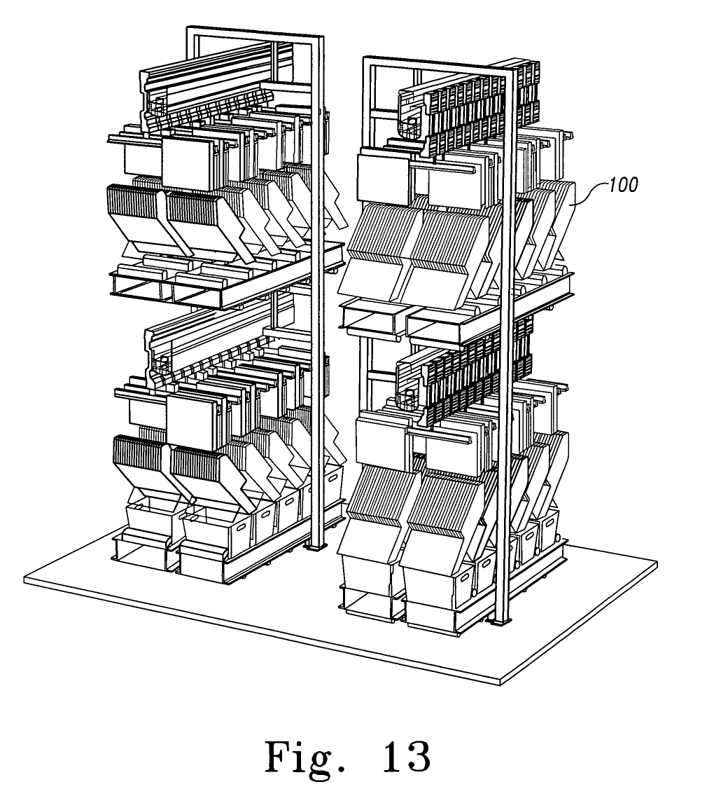

The conveyor systems of the present invention may be provided on multiple levels. Thus, as shown in FIG. 13, two or more track assemblies and associated cartridges, conveyors, etc. may be provided in a stacked arrangement in order to maximize the usage of floor space.

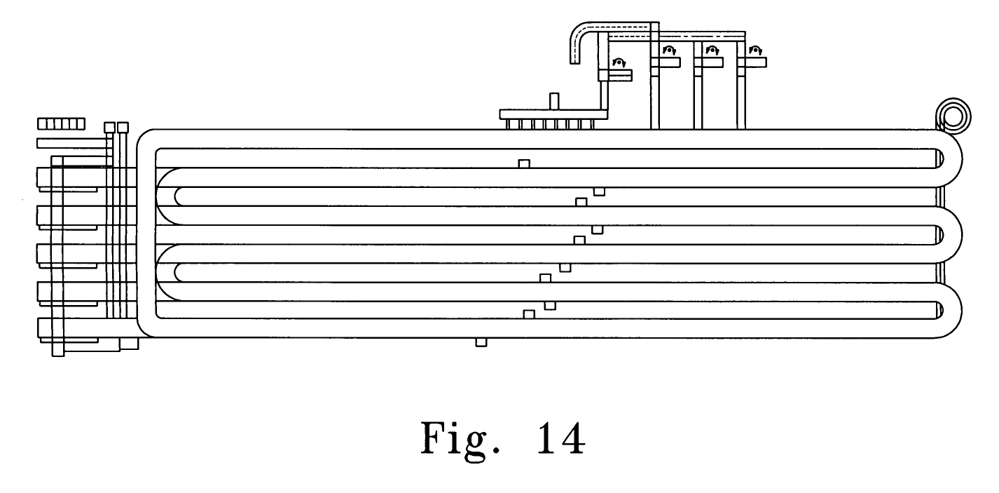

FIG. 14 depicts an exemplary layout having a separate induction leg, five sorter legs, and ten conveyors (two conveyors extending in parallel beneath each sorter leg). Along the induction leg, a letter feeder and several flats feeders are provided. A bin feeder is also provided at one end of the conveyors for positioning bins on the conveyors for receiving sorted postal articles. At the opposite end of the conveyors is provided a full bin transfer module for removing bins of sorted postal articles from the conveyors.

The specific illustrations and embodiments described herein are exemplary only in nature and are not intended to be limiting of the invention defined by the claims. Further embodiments and examples will be apparent to one of ordinary skill in the art in view of this specification and are within the scope of the claimed invention.

What is claimed is:

1. A conveyor system for conveying and/or sorting articles, said conveyor system comprises:
an endless track assembly having a conveying path; and
a plurality of cartridges for receiving articles and discharging said received articles, said cartridges supported from said track assembly and moveable along said conveying path, wherein said cartridges are configured to move transverse to said conveying path between at least two discharge positions.

2. The conveyor system as recited in claim 1, wherein the conveyor system further comprises a plurality of support rails operably configured to allow said cartridges to slideably move between said discharge positions.

3. The conveyor system as recited in claim 2, wherein said plurality of support rails suspend from said track assembly.

4. The conveyor system as recited in claim 1, wherein each of said cartridges comprises at least one compartment.

5. The conveyor system as recited in claim 1, wherein each of said cartridges comprises a discharge gate configured to open to discharge said articles.

6. The conveyor system as recited in claim 1, further comprising a feeder mechanism adapted to insert said articles into said cartridges.

7. The conveyor system as recited in claim 1, further comprising at least two conveyors adjacently located to said track assembly to receive said articles from said cartridges.

8. The conveyor system as recited in claim 7, further comprising a buffer module located between each of said cartridges and said conveyors when said cartridges are in said discharge positions.

9. The conveyor system as recited in claim 7, wherein said conveyors comprise discrete zones for receiving said articles.

10. The conveyor system as recited in claim 1, further comprising a control system for controlling the receiving and discharging of said articles.

11. The conveyor system as recited in claim 10, wherein said control system comprises one or more wires extending from each of said cartridges to provides communication for the receiving and/or discharging of said articles.

12. The conveyor system as recited in claim 1, further comprising a mechanical pusher located adjacent said track assembly to selectively move said cartridges between said discharge positions.

13. The conveyor system as recited in claim 1, further comprising a sliding shoe sorter to selectively move said cartridges between said discharge positions.

14. The conveyor system as recited in claim 1, further comprising a transverse drive mechanism to selectively move said cartridges between said discharge positions.

15. The conveyor system as recited in claim 14, wherein said transverse drive mechanism comprises a cartridge drive belt attached to each of said cartridges.

16. The conveyor system as recited in claim 1, wherein the conveyor system comprises multiple levels having two or more of said track assemblies and said associated plurality of cartridges.

17. The conveyor system as recited in claim 2, wherein the conveyor system further comprises carriage assemblies supporting said cartridges between said track assembly and said support rails.

18. A method for conveying and/or sorting articles, said method comprises:
receiving articles into a plurality of cartridges supported from an endless track assembly and moveable along a conveying path, wherein said cartridges are configured to move transverse to said conveying path between at least two discharge positions;
transporting said articles along said conveying path; and
discharging said articles from said cartridges at a predetermined location.

19. A cartridge for receiving and discharging received articles comprises:
a first support configured to attach to an endless track assembly for movement along a conveying path;
a second support configured to interface with a support rail, wherein said support rail allows said cartridge to slideably move between at least two discharge positions;
at least one compartment for containing articles; and
a discharge gate for discharging said articles from said cartridge at a predetermined location.

20. The conveyor system as recited in claim 19, wherein said cartridge slideably moves between said discharge positions in a direction transverse to the conveying path.

21. The conveyor system as recited in claim 19, wherein said articles located within each of said cartridges are vertically positioned relative to said cartridges.

22. A conveyor system comprising:
an endless track assembly having a conveying path;
a plurality of support rails;
a plurality of carriage assemblies suspended between said track assembly and said support rails; and
a plurality of cartridges for receiving and discharging articles, said cartridges moveable along said conveying path and configured to move transverse to said conveying path by said carriage assemblies between at least two discharge positions along said support rails.

23. The conveyor system as recited in claim 22, wherein each of said carriage assemblies comprise:
a mounting pin operably attached to said track assembly;
a control box assembly;
first and second suspension arms operably attached to said support rail; and
a motor box assembly, wherein said motor box assembly is suspended from said second arm and operably drives said cartridge along said support rail in the transverse direction.
